(19) United States
(12) Patent Application Publication
(10) Pub. No.: US 2022/0241144 A1
(43) Pub. Date: Aug. 4, 2022

(54) WEARABLE MASSAGE DEVICE

(71) Applicant: Guangzhou Pinai Technology Co., Ltd., Guangzhou (CN)

(72) Inventor: Lifu GU, Guangzhou (CN)

(73) Assignee: Guangzhou Pinai Technology Co., Ltd., Guangzhou (CN)

(21) Appl. No.: 17/585,978

(22) Filed: Jan. 27, 2022

(30) Foreign Application Priority Data
Feb. 2, 2021 (CN) 202120298685.8

(51) Int. Cl. A61H 19/00; A61H 23/00

(52) U.S. Cl. CPC A61H 19/30; A61H 2201/1652; A61H 23/00

(57) ABSTRACT

A wearable massage device is provided, which includes a ring and a first belt configured for mounting and fixing a massaging device. The first belt has two opposite ends connected to two sides of the loop, and at least one end of the first belt is detachably connected to the loop. The wearable massage device provided by the present application has a simple structure and high reliability in use, and is convenient for wearing and detaching.

### CROSS-REFERENCE TO RELATED APPLICATIONS

The present application claims the priority of the Chinese Patent Application No. 202120298685.8, filed on Feb. 2, 2021 and titled “Wearable Massage Device”. The disclosure of the aforementioned application is incorporated herein by reference.

### TECHNICAL FIELD

The present application relates to the field of wearable devices, in particular to a wearable massage device.

### BACKGROUND

In the related technology, massaging devices are arranged in some wearable massage devices. In order to clean and maintain the massaging devices, magnetic attraction structures are generally arranged on the wearable main body, and magnets are arranged in the massaging devices, the magnets are adsorbed and fixed by the magnetic attraction structures. Such products have the following disadvantages:

1. The adsorption and fixation of the magnets by the magnetic attraction structures is not reliable enough. When the massaging device vibrates and the human body moves, the massaging device may shift and the user's massage experience is poor.

2. The overall mass of the magnetic attraction structures and the magnets is too large, which increases the overall weight of the wearable device and the load of the user wearing the product.

### SUMMARY

The main purpose of the present application is to provide a wearable massage device, which is aimed at simplifying the structure of the wearable massage device and improving the reliability of the massaging device in use.

In order to achieve the purpose, the present application provides a wearable massage device including a loop and a first belt configured for mounting and fixing a massaging device,

the first belt has two opposite ends connected to two sides of the loop, and at least one end of the first belt is detachably connected to the loop.

In one embodiment of the present application, the loop includes two second belts,

two ends of one of the two second belts are detachably connected with two ends of another of the two second belts, and the two ends of the first belt are connected with the two second belts correspondingly.

In one embodiment of the present application, one end of each second belt is provided with at least one first protrusion and another end of each second belt is provided with at least one first hole,

the first protrusion of one of the two second belts is clamped in the first hole of the other of the two second belts.

In one embodiment of the present application, wherein one end of the first belt is provided with at least one second hole and another end of the first belt is provided with at least one second protrusion,

the loop is provided with two opposite connecting portions, one of the two connecting portions is provided with at least one third hole, and the other of the two connecting portions is provided with at least one third protrusion,

the at least one second protrusion is clamped in the at least one third hole, and the at least one third protrusion is clamped in the at least one second hole.

In one embodiment of the present application, the first belt includes a main segment and at least two first branch segments,

the at least two first branch segments are arranged at one end of the main segment, an end of the main segment far away from the at least two first branch segments is connected with the loop, and an end of each of the at least two first branch segments far away from the main segment is connected with the loop.

In one embodiment of the present application, the first belt further includes at least two second segments,

the at least two second branch segments are arranged at the end of the main segment far away from the at least two first branch segments;

an end of each of the at least two second branch segments away from the main segment is connected with the loop.

In one embodiment of the present application, the first belt is provided with a limiting groove arranged far away from the loop;

the massaging device is accommodated and fixed in the limiting groove.

In one embodiment of the present application, a bottom wall of the limiting groove is defined with an avoidance opening.

In one embodiment of the present application, the first belt is defined with a function hole spaced from the limiting groove.

In one embodiment of the present application, the at least one end of the first belt is provided with a reinforcing portion connected with the loop.

The wearable massage device in the technical solutions of the present application includes a loop and a first belt. The first belt is provided with two opposite ends, the two ends of the first belt are connected to two sides of the loop correspondingly, and at least one end of the first belt is detachably connected to the loop. The first belt is configured for mounting and fixing a massaging device. Therefore, the wearable massage device includes the loop and the belt, and has a simple structure, a small weight and is convenient for wearing. At least one end of the first belt is detachably connected with the loop, which is convenient for wearing and detaching of the wearable body. The massaging device is installed and fixed on the first belt, thus avoiding the movement of the massaging device relative to the wearable body, and ensuring the stability of the massaging device during working and the reliability of the wearable massage device in use.

### BRIEF DESCRIPTION OF THE DRAWINGS

In order to more clearly explain the embodiments of the present application or the technical schemes in the related art, the drawings required in the description of the embodiments or the related art will be briefly described below. It is obvious that the drawings described below are only some embodiments of the present application. Without any creative effort, those of ordinary skilled in the art can obtain other drawings from the structure shown in these drawings.

FIG. 1 is a structural schematic view of a wearable massage device according to a first embodiment of the present application.

FIG. 2 is an explosion view of the wearable massage device of FIG. 1.

FIG. 3 is a structural schematic view of the wearable massage device according to a second embodiment of the present application.

FIG. 4 is a structural schematic view of the wearable massage device according to a third embodiment of the present application.

FIG. 5 is a structural schematic view of the wearable massage device according to a fourth embodiment of the present application.

FIG. 6 is a structural schematic view of the wearable massage device according to a fifth embodiment of the present application.

FIG. 7 is a structural schematic view of the wearable massage device according to a sixth embodiment of the present application.

The realization of the purposes, functional features and advantages of the present application will be further explained with reference to the accompanying drawings in combination with the embodiments.

### DETAILED DESCRIPTION OF THE EMBODIMENTS

The technical solution in the embodiments of the present application will be clearly and completely described in combination with the drawings in the embodiments of the present application. Obviously, the described embodiments are only a part of the embodiments of the present application, not all of the embodiments. Based on the embodiments of the present application, all other embodiments obtained by those skilled in the art without creative effort fall in the scope of the present application.

It should be noted that all directivity indications (such as up, down, left, right, front, back, etc.) in the embodiments of the present application are only used to explain the relative position relationships and movement situations among various components under a specific posture (as shown in the attached figures). If the specific posture is changed, the directivity indications are changed accordingly.

In the present application, the terms “connected” and “fixed” should be understood in a broad sense unless otherwise expressly specified and limited. For example, “fixed” can be a fixed connection, a detachable connection or being integrated into a whole; it can be a mechanical connection or an electrical connection; it can be directly connected or indirectly connected through an intermediate medium, or be an internal connection between two elements or an interactive relationship between two elements, unless otherwise expressly defined. For those of ordinary skill in the art, the specific meanings of the above terms in the present application can be understood according to specific conditions.

In addition, descriptions such as “first”, “second” and the like in the present application are for descriptive purposes only, and should not be understood as indicating or implying relative importance of indicated technical features or implicitly indicating the number of the indicated technical features. Thus, the features defined as “first”, “second” may explicitly or implicitly include at least one of the features. The meaning of “and/or” in the whole text is to include three parallel schemes, taking “A and/or B as an example”, “A and/or B” includes scheme A, or scheme B, or both schemes A and B. In addition, the technical solutions among the various embodiments can be combined with each other, but the combination must be based on the realization by those ordinary skill in the art. When the combination of the technical solutions is contradictory or unable to be realized, it should be considered that the combination of the technical solutions does not exist and is not within the scope of the present application.

The present application provides a wearable massage device, which is configured for massage and health care of human bodies and has medical and health care effect.

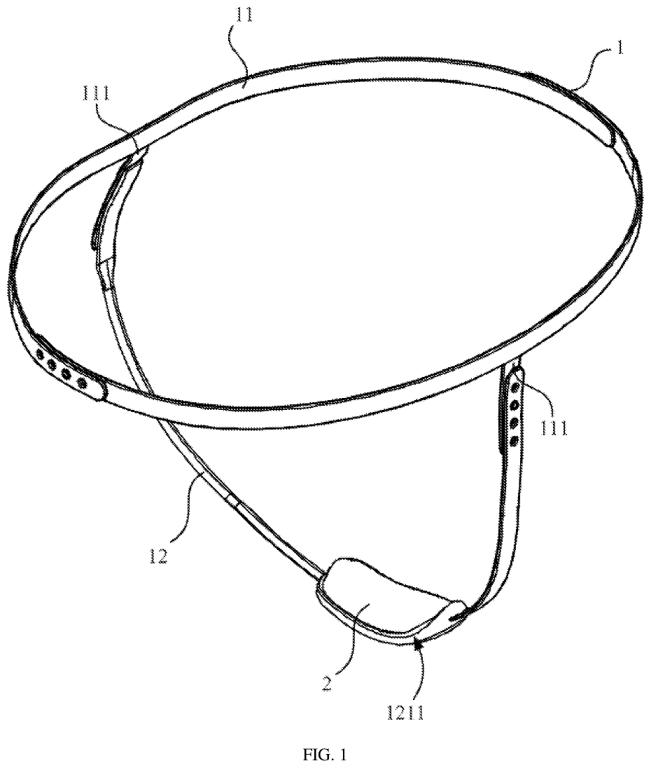

In an embodiment of the present application, as shown in FIG. 1, the wearable massage device includes a loop and a first belt, the first belt 12 has two opposite ends connected to two sides of the loop 11 correspondingly, and at least one end of the first belt 12 is detachably connected to the loop 11. The first belt 12 is configured for mounting and fixing a massaging device.

In this embodiment, the loop 11 is wearable on a waist of a human body. When the loop 11 is worn on the waist of the human body, the first belt 12 is located between two legs of the human body. The loop 11 and the first belt 12 can be connected to form a wearable body 1, which can be of a structure like a G-string or a T-back and is convenient for a human body to wear. The loop 11 and the first belt 12 may be made of an elastic material so that the loop 11 and the first belt 12 have good ductility and are suitable for users of different body sizes. The loop 11 and the first belt 12 may also be made of cloth, cotton or a composite material with a plurality of materials. As an example, the material of the loop 11 and the first belt 12 is silicone, so that the loop 11 and the first belt 12 are skin-friendly and have good strength and resilience, and the wearing experience of the users is improved.

Both ends of the first belt 12 being connected to two sides of the loop 11 includes that: the both ends of the first belt 12 are connected to an outer circumferential surface of the loop 11; one end of the first belt 12 is connected to the outer circumferential surface of the loop 11, and the other end of the first belt 12 is connected to an inner circumferential side of the loop 11; and the both ends of the first belt 12 are connected to the inner circumferential surface of the loop 11. When the first belt 12 and the loop 11 are connected, the first belt 12 and the loop 11 have two junctions which can be distributed symmetrically along a radial direction of the loop 11, or one junction is distributed far away from the other, so that there is a sufficient distance between the two junctions of the first belt 12 and the loop 11 to facilitate the wearing of the wearable body 1.

At least one end of the first belt 12 being detachably connected to the loop 11 includes that: one end of the first belt 12 is detachably connected to the loop 11, and the other end of the first belt 12 is fixedly connected to the loop 11; the both ends of the first belt 12 are fixedly connected with the loop 11; and the both ends of the first belt 12 are detachably connected with the loop 11. The detachable connection between the first belt 12 and the loop 11 can be realized by clamping or plugging-in, or the like, which is not limited here. The fixed connection between the first belt 12 and the loop 11 includes, but is not limited to, the integral molding of the first belt 12 and the loop 11, and the sticking of the first belt 12 and the loop 11.

The massaging device 2 is configured for massaging organs or acupuncture points of the human body. The massaging device 2 can be arranged on a side of the first belt 12 facing the loop 11. The massaging device 2 can be a vibrating massaging device. When the wearable body 1 is worn on the human body, the massaging device 2 abuts against the organs or the acupuncture points of the human body and vibrates to realize massage and health care of the human body. The connection between the massaging device 2 and the first belt 12 can be realized by clamping or plugging-in, or the like, which is not limited here. When the massaging device 2 and the first belt 12 is detachably connected, the massaging device 2 can be conveniently installed on or disassembled from the first belt 12, thereby facilitating the installation and use of the massaging device 2, as well as the cleaning, overhauling and maintenance of the massaging device 2. The outer side of the massaging device 2 can be wrapped and covered with silicone, and the silicone has the characteristics of skin-friendly and corrosion resistance of sweat, grease and the like, which is beneficial to improving the comfort of the massaging device 2 in use and prolonging the service life of the massaging device 2.

In the technical solution of the present application, the loop 11 and the belt can be connected to form a wearable body 1. The wearable body 1 has the advantages of simple structure, convenient for wearing and small weight, which is beneficial to realizing the lightweight design of the wearable massage device. At least one end of the first belt 12 is detachably connected to the loop 11 to facilitate the wearing and detaching of the wearable body 1. The massaging device 2 is connected and fixed to the first belt 12, so that the massaging device 2 is prevented from moving relative to the wearable body 1, and the stability of the massaging device 2 and the reliability of the wearable massage device in use are ensured.

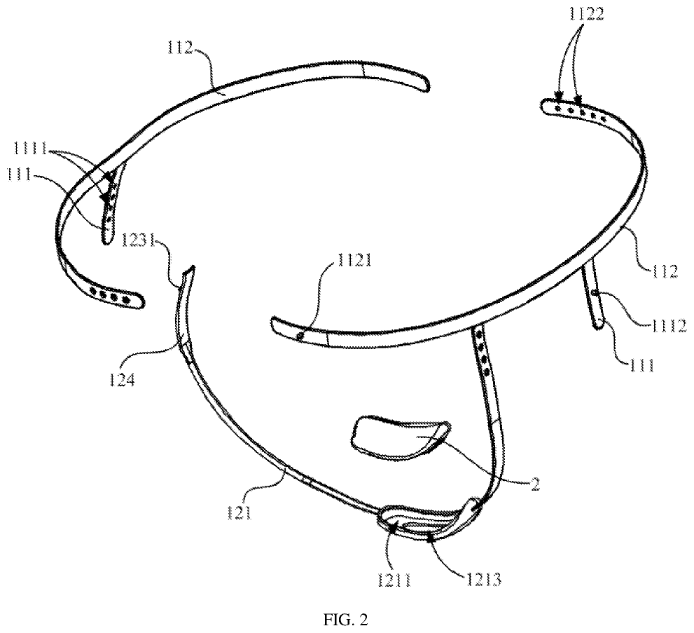

In one embodiment of the present application, as shown in FIGS. 1 and 2, the loop 11 includes two second belts 112. Two ends of one second belt 112 are detachably connected to two ends of another second belt 112 correspondingly, and the two ends of the first belt 12 are connected to the two second belts 112 correspondingly.

In this embodiment, each second belt 112 has two ends, and the two ends of one second belt 112 are connected to the two ends of the other second belt 112 correspondingly, so that the two second belts 112 are connected to form a loop and form the loop 11. The two second belts 112 can be detachably connected by means of clamping or the like, so as to improve the convenience of wearing and detaching of the second belts 112 and facilitate the use of the wearable massage device.

In an embodiment of the present application, as shown in FIGS. 1 and 2, one end of each second belt 112 is provided with at least one first protrusion 1121, and the other end is provided with at least one first hole 1122. The first protrusion 1121 of one second belt 112 is clamped in the first hole 1122 of the other second belt 112.

In this embodiment, each first protrusion 1121 may be a convex structure on the second belt 112, each first protrusion 1121 can be arranged on an inner side wall or an outer side wall of the second belt 112, and each first protrusion 1121 can be integrally formed with the second belt 112. When only one first hole 1122 and one first protrusion 1121 are provided on each second belt 112, the first protrusion 1121 on one second belt 112 is clamped in the first hole 1122 on the other second belt 112 to realize the detachable connection of the two second belts 112, so as to improve the convenience of wearing and detaching of the wearable massage device. When each second belt 112 is provided with two or more first holes 1122, and two or more first protrusions 1121, a first protrusion 1121 on one second belt 112 can be selectively clamped in a first hole 1122 on another second belt 112, so that a girth of the loop 11 formed after the two second belts 112 are connected can be adjusted, and the loop 11 can be applied to users with different waistlines, and the applicability of the wearable massage device can be improved. The more the number of the first protrusions 1121 and the number of the first holes 1122 that are clamped and mated on the two second belts 112 are, the more favorable it is to improve the reliability and tightness of the connection between the two belts 11.

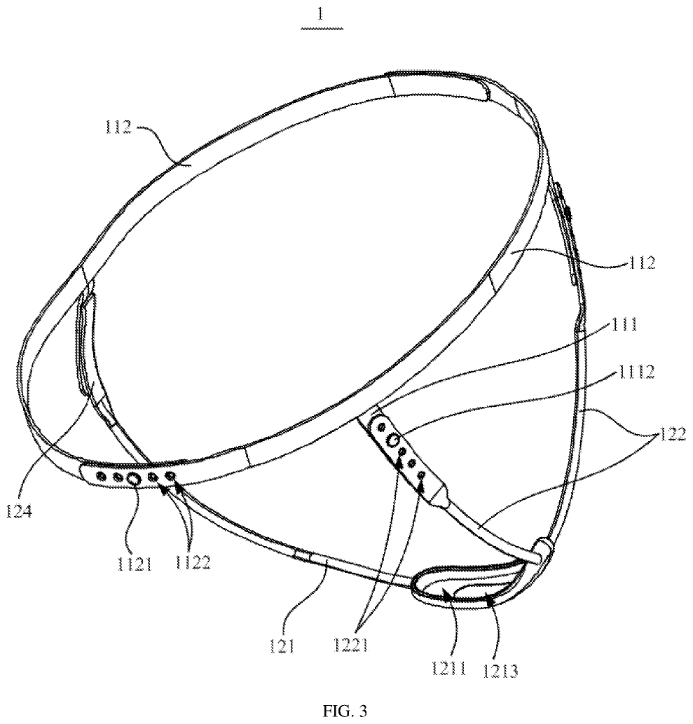

In an embodiment of the present application, as shown in FIGS. 2 and 3, one end of the first belt 12 is provided with at least one second hole 1221, and the other end is provided with at least one second protrusion 1231. The loop 11 is provided with two connecting portions 111 opposite to each other, one connecting portion 111 is provided with at least one third hole 1111, and the other connecting portion 111 is provided with at least one third protrusion 1112. The second protrusion 1231 is clamped in the third hole 1111, and the third protrusion 1112 is clamped in the second hole 1221.

In this embodiment, the two connecting portions 111 can be distributed on the two second belts 112. The connecting portions 111 can be formed in a shape of a strip, a block, or the like. One end of each connecting portion 111 is connected to the loop 11, and the other end of the connecting portion 111 is detachably connected to the first belt 12 through the clamping of the second hole 1221 and the third protrusion 1112, or the clamping of the second protrusion 1231 and the third hole 1111. When only one second hole 1221 is provided on the first belt 12, and only one third hole 1111 is provided on the loop 11, a second protrusion 1231 on the first bundle Belt 12 is clamped in the third hole 1111 on the loop 11, and a third protrusion 1112 on the loop 11 is clamped in the second hole 1221 on the first belt 12, thus realizing the detachable connection between the first belt 12 and the loop 11 and improving the convenience of wearing and detaching of the wearable massage device. When two or more second holes 1221 are provided on the first belt 12, and two or more third holes 1111 are provided on the loop 11, each second protrusion 1231 can be selectively clamped in a third hole 1111, and each third protrusion 1112 can be selectively clamped in a second hole 1221, so that the distance between the side of the first belt 12 far away from the loop 11 and the loop 11 can be adjusted, and the wearable massage device is suitable for users of different heights. The more the number of the second holes 1221 and the number of the third protrusions 1112 are, and/or the more the number of the second protrusions 1231 and the number of the third holes 1111 are, the more favorable it is to improve the reliability and tightness of the connection between the first belt 12 and the connecting portions 111.

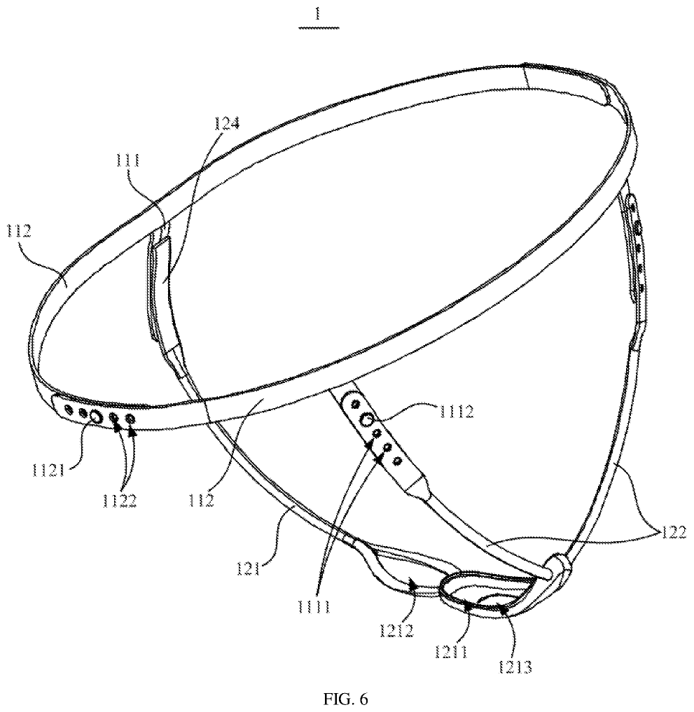

In an embodiment of the present application, as shown in FIGS. 3 and 6, the first belt 12 includes a main segment 121 and at least two first branch segments 122. The at least two first branch segments 122 are provided at one end of the main segment 121, an end of the main segment 121 away from the first branch segment 12 is connected to the loop 112, and an end of each first branch segment 122 away from the main segment 121 is connected to the loop 11.

In this embodiment, the main segment 121 and the first branch segments 122 can be integrally formed. The at least two first segments 122 are connected to one of the second belts 112, and the end of the main segment 121 away from the first branch segments 122 can be connected to another of the second belts 112. The main segment 121 and either of the first branch segments 122 are thus connected to the two second belts 112 correspondingly. The junction of each the first branch segment 122 with the loop 11 is disposed away from the junction of the main segment 121 with the loop 11. When the loop 11 is worn on the waist of the human body, the main segment 121 and each of the first branch segments 122 can be partially located between the legs of the human body, thereby facilitating the stability and reliability of the wearable body 1. The first branch segments 122 can share the stress generated when the main segment 121 is connected to the loop 11, thereby improving the reliability and stability of the connection between the main segment 121 and the loop 11. The first branch segments 122 can be connected to the loop 11 directly or through the connecting portions 111.

The massaging device 2 can be provided at the main segment 121, or the massaging device 2 can be provided at the first branch segments 122, or the massaging device 2 can be arranged at the junction of the main segment 121 with the first branch segments 122. The position of the massaging device 2 can be designed and adjusted according to actual requirements.

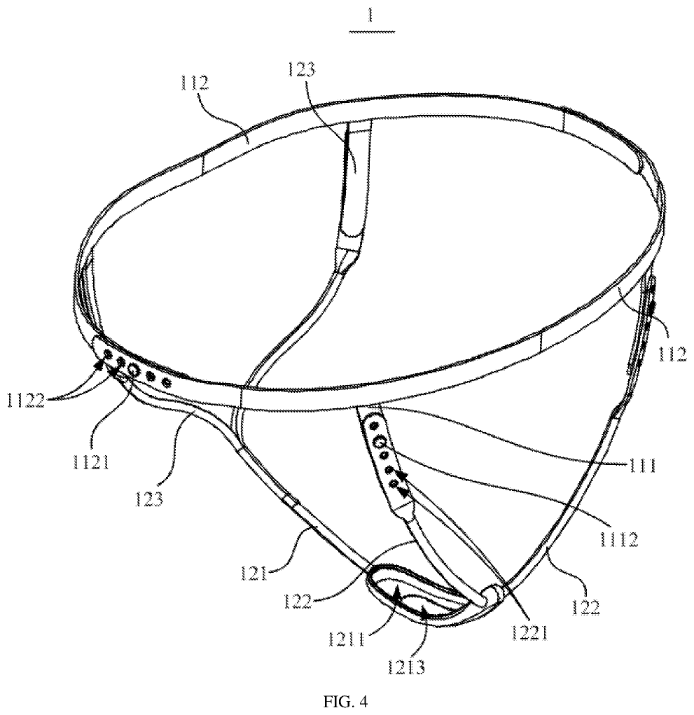

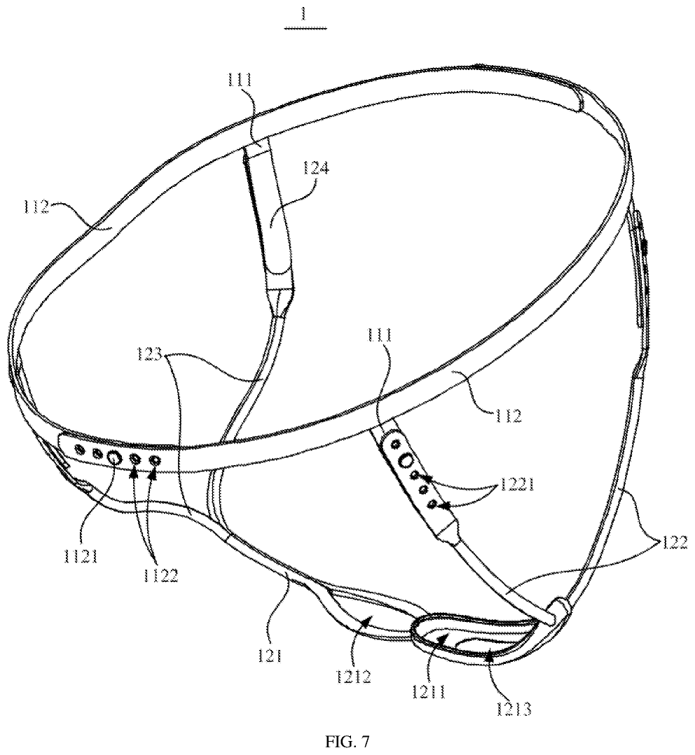

In an embodiment of the present application, as shown in FIGS. 4 and 7, the first belt 12 further includes at least two second branch segment 123. The at least two second branch segments 123 are provided at the end of the main segment 121 away from the first branch segments 122. An end of each second branch segments 123 away from the main segment 121 is connected to the loop 11.

In this embodiment, each first branch segment 122 is connected to one of the second belts 112, each second branch segment 123 is connected to another of the second belts 112, such that the junction of each first branch segment 122 with the loop 11 is disposed away from the junction of each second branch segment 123 with the loop 11. When the loop 11 is worn on the waist of the human body, the main segment 121 and each second branch segment 123 can be partially located between the legs of the human body, thereby facilitating the stability and reliability of the wearable body 1 on the human body. By arranging a plurality of first branch segments 122 and a plurality of second branch segments 123, the stress generated when the main segment 121 is connected with the loop 11 can be shared, and the reliability and stability of the connection between the main segment 121 and the loop 11 can be improved. The second branch 123 can be connected to the loop 11 directly or through the connecting portions 111. Each second belt 112 can be provided with at least two connecting portions 111, and each first branch segment 122 can be connected with a connecting portion 111 on one of the second belts 112, and each second branch segment 123 can be connected with a connecting portion 111 on another of the second belts 112. By arranging a plurality of connecting portions 111, the loop 11 can be connected with a plurality of first branch segments 122 and a plurality of second branch segments 123 through the plurality of connecting portions 111, thus improving the reliability and stability of the wearable body 1 on the human body.

In an embodiment of the present application, as shown in FIG. 2, the first belt 12 is provided with a limiting groove 1211 away from the loop 11. The massaging device 2 is accommodated and bound in the limiting groove 1211 for abutting and massaging the human body.

In this embodiment, the limiting groove 1211 is configured for fixing the massaging device 2. The limiting groove 1211 can be provided on a side of the first belt 12 facing the loop 11. The shape and size of the limiting groove 1211 are adapted to the shape and size of the massaging device 2, such that the massaging device 2 can be at least partially accommodated in the limiting groove 1211. The outer wall of the massaging device 2 and the inner wall of the limiting groove 1211 are in contact with each other for limiting the position of the massaging device 2, so that the massaging device 2 is reliably positioned in the limiting groove 1211, preventing the massaging device 2 from shifting along with its own vibration or human body's activities when the wearable massage device is worn on the human body for use, and ensuring the reliability of the massaging device 2 in use.

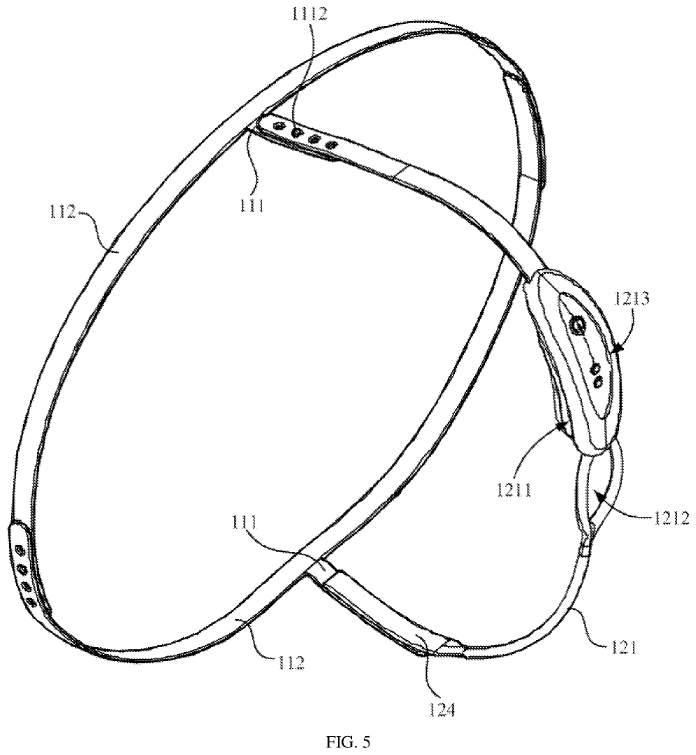

In an embodiment of the present application, as shown in FIG. 2 and FIG. 5, a bottom wall of the accommodating groove is provided with an avoidance opening 1213.

In this embodiment, buttons and indicating lights are provided on the massaging device 2, the buttons include but are not limited to a power button and a strength adjustment button. The indicating lights include, but are not limited to, a power-on indicating light and a strength indicating light. The avoidance opening 1213 is configured for avoiding the buttons and indicating lights on the massaging device 2, so as to powering on or off and strength adjustment of the massaging device 2 can be carried out by the users through the avoidance opening 1213, and at the same time, the indicating lights of the massaging device can be viewed through the avoidance opening 1213 to let the users to know a current working state of the massaging device 2.

In an embodiment of the present application, as shown in FIGS. 5 to 7, the first belt 12 is provided with a function hole 1212 spaced away from the limiting groove 1211.

In this embodiment, the function hole 1212 serves as an auxiliary opening for massage of human organs, and can facilitate massage and health care of human body through the function hole 1212. The arrangement of the function hole 1212 enriches the massage scenarios and functions of the wearable massage device, and improves the flexibility of the wearable massage device in use. The function hole 1212 may be disposed adjacent to or away from the limiting groove 1211, and the spacing and relative position between the function hole 1212 and the limiting groove 1211 can be designed and adjusted according to actual needs.

In an embodiment of the present application, as shown in FIG. 2 and FIG. 5, at least one end of the first belt 12 is provided with a reinforcing portion 124 connected with the loop 11.

In this embodiment, the reinforcing portion 124 is configured for reinforcing an end portion of the first belt 12, so as to improve the structural strength of the junction of the first belt 12 with the loop 11, thereby the junction of the first belt 12 and the loop 11 is not easy to break, and the reliability and safety of the wearable massage device during wearing and using are improved.

The above are only preferred embodiments of the present application, and are not therefore limiting the scope of the present application. Any equivalent structure transformation made by using the contents of the specification and drawings of the present application, or any direct/indirect application in other related technical fields under the inventive concept of the present application is included in the claimed scope of the present application.

What is claimed is:

1. A wearable massage device comprising a loop and a first belt configured for mounting and fixing a massaging device,
wherein the first belt has two opposite ends connected to two sides of the loop, and at least one end of the first belt is detachably connected to the loop.

2. The wearable massage device of claim 1, wherein the loop comprises two second belts,
two ends of one of the two second belts are detachably connected with two ends of another of the two second belts, and the two ends of the first belt are connected with the two second belts correspondingly.

3. The wearable massage device of claim 2, wherein one end of each second belt is provided with at least one first protrusion and another end of each second belt is provided with at least one first hole,
the first protrusion of one of the two second belts is clamped in the first hole of the other of the two second belts.

4. The wearable massage device of claim 1, wherein one end of the first belt is provided with at least one second hole and another end of the first belt is provided with at least one second protrusion,
the loop is provided with two opposite connecting portions, one of the two connecting portions is provided with at least one third hole, and the other of the two connecting portions is provided with at least one third protrusion,
the at least one second protrusion is clamped in the at least one third hole, and the at least one third protrusion is clamped in the at least one second hole.

5. The wearable massage device of claim 1, wherein the first belt comprises a main segment and at least two first branch segments,
the at least two first branch segments are arranged at one end of the main segment, an end of the main segment far away from the at least two first branch segments is connected with the loop, and an end of each of the at least two first branch segments far away from the main segment is connected with the loop.

6. The wearable massage device of claim 5, wherein the first belt further comprises at least two second segments,
the at least two second branch segments are arranged at the end of the main segment far away from the at least two first branch segments;
an end of each of the at least two second branch segments away from the main segment is connected with the loop.

7. The wearable massage device of claim 1, wherein the first belt is provided with a limiting groove arranged far away from the loop;
the massaging device is accommodated and fixed in the limiting groove.

8. The wearable massage device of claim 7, wherein a bottom wall of the limiting groove is defined with an avoidance opening.

9. The wearable massage device of claim 1, wherein the first belt is defined with a function hole spaced from the limiting groove.

10. The wearable massage device of claim 1, wherein the at least one end of the first belt is provided with a reinforcing portion connected with the loop.
